(19) United States
(12) Patent Application Publication
(10) Pub. No.: US 2008/0047976 A1
(43) Pub. Date: Feb. 28, 2008

(54) TAMPER-EVIDENT FLIP-TOP CLOSURE

(75) Inventors: Peter Scheer, Camp Hill, PA (US); Brian Dombroski, Lancaster, PA (US)

Correspondence Address: BARNES & THORNBURG LLP, 11 SOUTH MERIDIAN, INDIANAPOLIS, IN, 46204, US

(73) Assignee: BERRY PLASTICS CORPORATION, Evansville, IN (US)

(21) Appl. No.: 11/838,686

(22) Filed: Aug. 14, 2007

Related U.S. Application Data
(60) Provisional application No. 60/823,207, filed on Aug. 22, 2006.

(51) Int. Cl. B67D 5/32

(52) U.S. Cl. 222/153.06

(57) ABSTRACT

A tamper-evident closure is adapted to mount on a filler neck of a container. The closure includes a body, a flip-top cap, and a hinge coupled to the body and the flip-top cap. The body and the cap cooperate to define a tamper-evident indicator that breaks to the first time the flip-top cap has opened to indicate that the flip-top cap has been opened.

This application claims priority under 35 U.S.C. §119(e) to U.S. Provisional Application Ser. No. 60/823,207, filed Aug. 22, 2006, which is expressly incorporated by reference herein.

### BACKGROUND

The present disclosure relates to closures for mounting on the top of bottles or other containers, and in particular to a container closure including a “flip-top“cap. More particularly, the present disclosure relates to a tamper-evident closure.

Closures are provided to cover product-dispensing openings formed in bottles or other containers. It is known to provide a “tamper-evident” tear strip that is coupled to a portion of the closure. If the tear strip is missing when a consumer purchases a bottle or other container, then the consumer is put on notice that someone may have tampered with the bottle and gained unauthorized access to product stored in the bottle through the opening covered normally by the closure. After the tear strip is removed, a remaining portion of the closure is used to retain the closure in place on the bottle.

### SUMMARY

According to the present disclosure, a tamper-evident closure includes a body formed to include a product-dispensing spout and adapted to mount on a filler neck of a bottle or other container. The closure also includes a cap adapted for movement from a closed position on the body covering the product-dispensing spout to an opened position away from the body uncovering the product-dispensing spout.

In illustrative embodiments, the tamper-evident closure includes a tamper-evident indicator that extends into an aperture formed in the cap. The tamper-evident indicator is configured to break the first time the cap is removed from the body to provide a visual indication that the cap has been opened at least once.

In one illustrative embodiment, the tamper-evident indicator includes a frangible “cap-opened” signal flag included in the body and this signal flag breaks the first time the cap is opened. The signal flag is defined by a breakaway head mounted on a head-support pillar and located above or in the aperture formed in the cap. The breakaway head separates from the head-support pillar during first-time movement of the cap relative to the body from the closed position to the opened position to provide a visual indication that the cap has been opened at least once.

In other illustrative embodiments, the tamper-evident indicator includes a head-support pillar included in the body and a breakaway head and several frangible tether strips included in the cap. The breakaway head is mounted on the head-support pillar and coupled to a top wall of the cap by the frangible tether strips. The frangible tether strips break during first-time movement of the cap relative to the body from the closed position to the opened position to provide a visual indication that the cap has been opened at least once.

Additional features of the disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIGS. 1-4 illustrate a first embodiment of a tamper-evident “flip-top” closure in accordance with the present disclosure;

FIG. 1 is perspective view of a container closure prior to manufacture of a tamper-evident indicator for the closure and showing that the closure includes a body formed to include a product-dispensing spout and an upstanding pole, a flip-top cap formed to include a flag receiver, and a hinge interconnecting the body and the flip-top cap and showing that the flip-top cap is oriented to lie in an “opened” position;

FIG. 2 is a perspective view of the container closure of FIG. 1 after the flip-top cap has been moved to assume a “closed” position (for the first time) on the body to cause the upstanding pole to extend through an aperture defined by the flag receiver formed in the flip-top cap;

FIG. 3 is a perspective view similar to FIG. 2 after a tool (not shown) is used to form an exposed free end of the upstanding pole to include a “breakaway” head while the flip-top cap remains in the closed position;

FIG. 3A is a partial perspective view of the body of FIG. 3 showing a frangible cap-opened signal flag in accordance with a first embodiment of the present disclosure coupled to a top wall of the present disclosure of the body and showing that the signal flag includes a breakaway head and a head-support pillar interconnecting the breakaway head and the top wall prior to separation of the breakaway head from the head-support pillar in a manner shown, for example, in FIG. 4;

FIG. 3B is a view similar to FIG. 3A of a frangible cap-opened signal flag having a smaller breakaway head and a shorter head-support pillar in accordance with another embodiment of the present disclosure;

FIG. 3C is a sectional view taken along line 3C-3C of FIG. 3B showing the breakaway head included in the frangible cap-opened signal flag of FIG. 3B located in an open recess formed in the top wall of the body above a thin annular plate included in that top wall;

FIG. 4 is a perspective view similar to FIG. 1 showing separation of the breakaway head from an underlying head-support pillar included in the upstanding pole upon “first” movement of the flip-top cap on the hinge relative to the body to assume the opened position (after formation of the breakaway head in the upstanding pole) to provide a “tamper-alert” signal to an observer indicating that the container closure has been “opened” at least one time after formation in the container closure of a tamper-evident indicator comprising the breakaway head;

FIGS. 5-9 illustrate a second embodiment of a tamper-evident flip-top closure in accordance with the present disclosure;

FIG. 5 is a perspective view of a container closure including a body, a flip-top cap, and a hinge prior to mating engagement of a breakaway head included in the flip-top cap with a distal end of a head-support pillar included in the body to establish a tamper-evident indicator shown, for example, in FIG. 8;

FIG. 6 is a perspective view of the container closure of FIG. 5 after the flip-top cap has been moved to assume a closed position on the body;

FIG. 7 is perspective view similar to FIG. 6 showing downward movement of the breakaway head relative to the top wall of the flip-top cap toward the underlying head-support pillar to “stretch” four frangible tether strips used to tether the breakaway head to the top wall of the flip-top cap;

j FIG. 8 is an enlarged sectional view taken along line 8-8 of FIG. 7 showing mating engagement of the tethered breakaway head to the head-support pillar rooted on a top wall of the body to establish an illustrative tamper-evident indicator;

FIG. 9 is a perspective view similar to FIG. 5 showing separation of the breakaway head from the top wall of the flip-top cap after breakage of the frangible tether strips upon movement of the flip-top cap on the hinge relative to the body to assume the opened position to provide a “tamper-alert” signal to an observer indicating that the container closure has been “opened” at least once after the breakaway head was first mated to the head-support pillar;

FIGS. 7A and 8A show a variation of the second embodiment shown in FIGS. 5-9 wherein the breakaway head is “twisted” (e.g., rotated in a counterclockwise direction about a vertical axis) as it is mated with the underlying head-support pillar to tension the frangible tether strips further;

FIGS. 10-12 illustrate a third embodiment of a tamper-evident flip-top closure in accordance with the present disclosure;

FIG. 10 is a perspective view of a container closure including a body including a two-piece frangible cap-opened signal flag, a flip-top cap formed in include a flag receiver, and a hinge prior to mating engagement of first and second breakaway heads included in the two-piece frangible cap-opened signal flag with the flip-top cap to establish a tamper-evident indicator shown, for example, in FIG. 11;

FIG. 11 is a perspective view of the container closure of FIG. 10 after the flip-top cap has been moved to assume a closed position and showing the tamper-evident indicator in a “ready” position before the first “opening” of the flip-top cap;

FIG. 11A is a sectional view taken along line 1A-1A of FIG. 11 showing first and second frangible posts included in the two-piece frangible cap-opened signal flag coupled to the body and arranged to extend upwardly through a flag-receiving aperture formed in the flip-top cap; and

FIG. 12 is a perspective view similar to FIG. 10 showing separation of the first breakaway head from a first head-support pillar included in the first frangible post and separation of the second breakaway head from a second head-support pillar included in the second frangible post upon “first-time” movement of the flip-top cap on the hinge relative to the body to assume the opened position to provide a “tamper-alert” signal to an observer indicating that the container closure has been opened at least once after establishment in the container closure of a tamper-evident indicator comprising the first and second breakaway heads.

### DETAILED DESCRIPTION

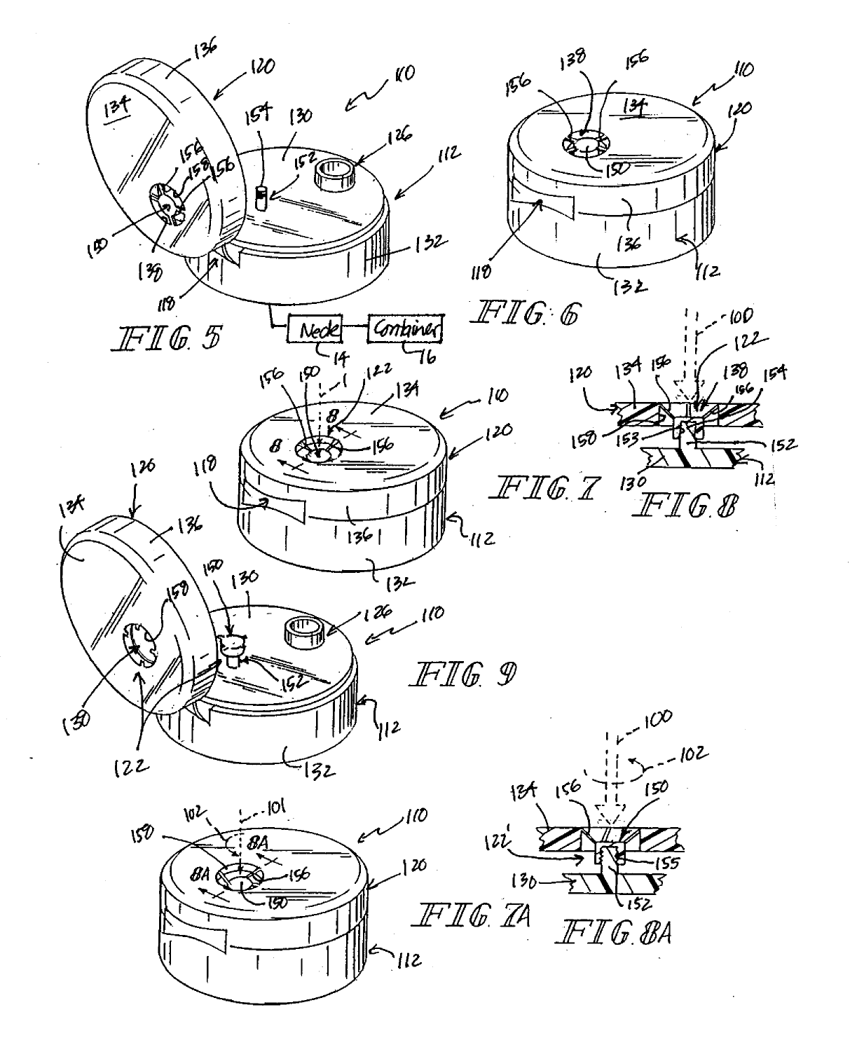

A container closure 10 includes a body 12 adapted to mount on a neck 14 of a container 16, a hinge 18, and a flip-top cap 20 as shown, for example, in FIG. 1. Body 12 and flip-top cap 20 cooperate to define a tamper-evident indicator 22 as suggested in FIG. 3. A breakaway head 50 included in tamper-evident indicator 22 separates from a head-support pillar 52 also included in indicator 22 as suggested in FIG. 4 when a user “opens” flip-top cap 20 for the first time.

Closure 10 is monolithic and thus is formed as a single piece of plastics material, in three sections, to include body 12, hinge 18, and flip-top cap 20. Closure 10 is formed using any suitable injection-molding or compression-molding technique.

Body 12 includes a top wall 30 formed to include a product-dispensing spout 26 and an annular side wall 32 depending from a perimeter portion of top wall 30 as suggested in FIG. 1. An interior surface of annular side wall 32 is threaded or configured in any suitable manner to mate with a companion finish on an exterior surface of container neck 14 to mount container closure 10 on container neck 14. It is within the scope of this disclosure to provide any suitable fluid seal on the underside of top wall 30 to establish a sealed connection between body 12 and container neck 14 when closure 10 is mounted on container neck 14.

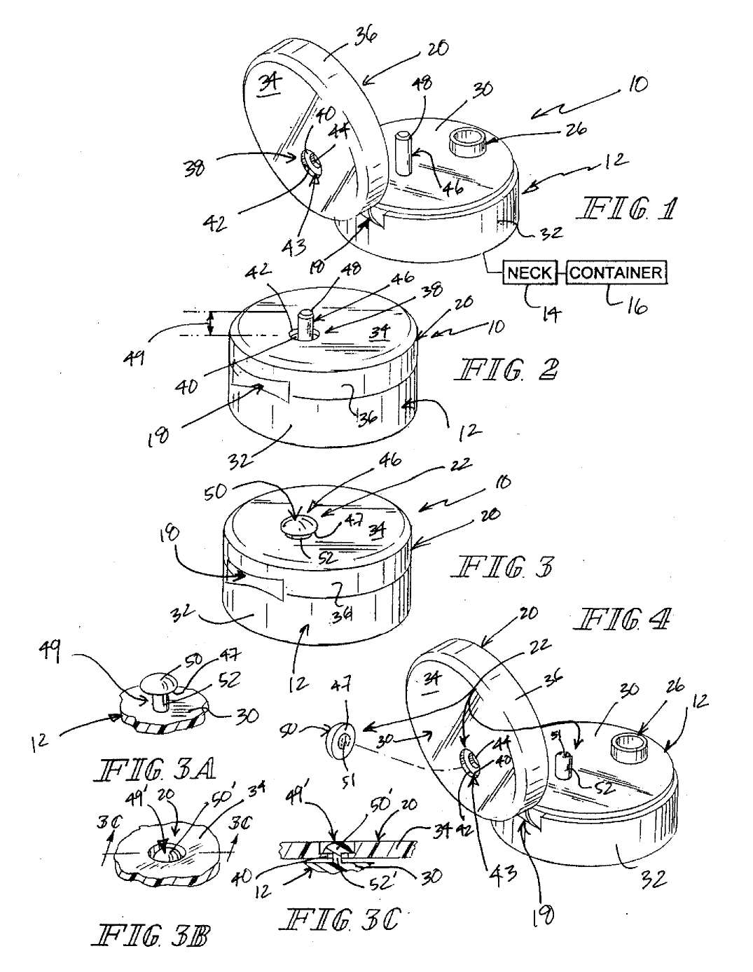

Flip-top cap 20 includes a top wall 34 and an annular side wall 36 depending from a peripheral portion of top wall 34 as suggested in FIGS. 1 and 2. Top wall 34 is formed to include a flag receiver 38 as shown, for example, in FIG. 1. In an illustrative embodiment, top wall 34 includes an outer plate 35 coupled to annular side wall 36 and flag receiver 38 coupled to outer plate 35 as suggested in FIG. 1. In an illustrative embodiment, flag receiver 38 includes a thin annular plate 40 coupled to a circular interior edge 42 formed in outer plate 35 of top wall 34 and annular plate 40 is formed to include a “flag-receiving” aperture 44. Annular plate 40 is arranged to lie in an opening defined by circular interior circular edge 42 as suggested in FIG. 1. Annular plate 40 cooperates with interior edge 42 to form an open recess 43 as suggested in FIGS. 1 and 4.

Hinge 18 is coupled to base 12 and to flip-top cap 20 to provide a “living” hinge as suggested in FIG. 1. Hinge 18 is flexible allowing tethered movement of flip-top cap 20 relative to base 12 after controlled breakage of tamper-evident indicator 22 in a manner shown, for example, in FIG. 4. It is within the scope of this disclosure to provide a container closure without a hinge.

Body 12 is formed to include an upstanding pole 46 coupled to top wall 30 and arranged to lie in spaced-apart relation to product-dispensing spout 26 as shown, for example, in FIG. 1. In an illustrative embodiment, upstanding pole 46 is a cylinder-shaped member having an outer diameter that is less than the diameter of flag-receiving aperture 44 formed in annular plate 40. Upstanding pole 46 is sized and arranged so that a free end 48 thereof passes through flag-receiving aperture 44 and extends a distance 49 above top wall 34 of flip-top cap 20 upon movement of flip-top cap 20 from an opened position away from body 12 as shown in FIG. 1 to a closed position mating with body 12 as shown in FIG. 1 during formation of tamper-evident indicator 22.

After flip-top cap 20 is “snapped” shut to assume the closed position shown in FIG. 2, free end 48 of upstanding pole 46 is deformed under heat and pressure using a suitable tool (not shown) to produce a frangible “cap-opened” signal flag 49 comprising a “breakaway” head 50 and a head-support pillar 52 as shown, for example, in FIG. 3A. Breakaway head 50 has an outer diameter that is greater than the diameter of flag-receiving aperture 44 and is mushroom-shaped in an illustrative embodiment. Thus, breakaway head 50 is included in upstanding pole 46 and coupled to the head-support pillar 52 also included in upstanding post 46. Annular side wall 36 of flip top cap 20 is arranged to surround head-support pillar 52 and product-dispensing spout 26 when flip-top cap 20 has been moved to assume the closed position on body 12 as suggested in FIG. 3.

Breakaway head 50 of frangible cap-opened signal flag 49 includes a bottom wall 47 coupled normally to head-support pillar 52 as suggested in FIGS. 3A and 4. Bottom wall 47 of breakaway head 50 is arranged to lie in closely confronting relation to an exterior surface of outer plate 35 of top wall 34 of flip-top cap 20 when flip-top cap 20 is retained in the closed position on body 12 as shown, for example, in FIG. 3. Bottom wall 47 is arranged to engage the exterior surface of outer plate 35 as suggested in FIG. 4 during “first-time” movement of flip-top cap 20 relative to body 12 from the closed position shown in FIG. 3 to an opened position shown in FIG. 4 to apply an external force to breakaway head 50 to break frangible cap-opened signal flap 49 and cause breakaway head 50 to separate from head-support pillar 52.

In an alternative illustrative embodiment, a breakaway head 50′ (slightly smaller in size than breakaway head 50) and a head-support pillar 52′ (slightly shorter in length than head-support pillar 52) is provided as suggested in FIGS. 3B and 3C. Breakaway head 50′ is sized to lie in open recess 43 formed in top wall 34 prior to separation of breakaway head 50′ from head-support pillar 52′ as suggested in FIGS. 3B and 3C. Breakaway head 50′ includes a bottom wall 47′ coupled to head-support pillar 52′ and arranged to lie in open recess 43 in closely confronting relation to thin annular plate 40 to engage annular plate 40 during first-time movement of flip-top cap 20 relative to body 12 from the closed position to the opened position to apply an external force to breakaway head 50′ to break frangible cap-opened signal flag 49′ and cause breakaway head 50′ to separate from head-support pillar 52′.

When flip-top cap 20 is opened “for the first time” by a user, breakaway head 50 of frangible cap-opened signal flag 49 will be sheared off along frangible plane 51 as suggested in FIG. 4 to provide a visual indication that flip-top cap 20 has been opened. Frangible plane 51 may lie at a junction between breakaway head 50 and head-support pillar 52 or may lie somewhere in head-support pillar 52. If breakaway head 50 is visible and present above flip-top cap 20 as shown in FIG. 3 or visible and present in open recess 43 formed in top wall 34 of flip-top cap 20 as shown in FIGS. 3B and 3C, then observers can be confident that flip-top cap 20 has been unopened since filling of container 16.

A container closure 110 in accordance with another illustrative embodiment of the present disclosure includes a body 112 adapted to mount on a neck 14 of a container 16, a hinge 118, and a flip-top cap 120 as shown, for example, in FIG. 5. Body 112 and flip-top cap 120 cooperate to define a tamper-evident indicator 122 as suggested in FIGS. 5, 3 and 8. In an illustrative embodiment, tamper-evident indicator 122 includes a breakaway head 150, a head-support pillar 152, and frangible tether strips 156 as shown, for example, in FIGS. 5 and 8. A breakaway head 150 included in tamper-evident indicator 122 separates from a top wall 134 of flip-top cap 120 upon breakage of frangible tether strips 156 as suggested in FIG. 9 when a user “opens” flip-top cap 120 for the first time to provide a visual indication that container closure 110 has been opened for the first time.

Closure 110 is monolithic and thus is formed as a single piece of plastics material, in three sections, to include body 112, hinge 118, and flip-top cap 120. Closure 110 is formed using any suitable injection-molding or compression-molding technique. It is within the scope of this disclosure to provide a container closure without a hinge.

Body 112 includes a top wall 130 formed to include a product-dispensing spout 126 and an annular side wall 132 depending from a perimeter portion of top wall 130 as suggested in FIG. 5. An interior surface of annular side wall 132 is threaded or configured in any suitable manner to mate with a companion finish on an exterior surface of container neck 14 to mount container closure 110 on container neck 14. It is within the scope of this disclosure to provide any suitable fluid seal on the underside of top wall 130 to establish a sealed connection between body 112 and container neck 14 when closure 110 is mounted on container neck 14.

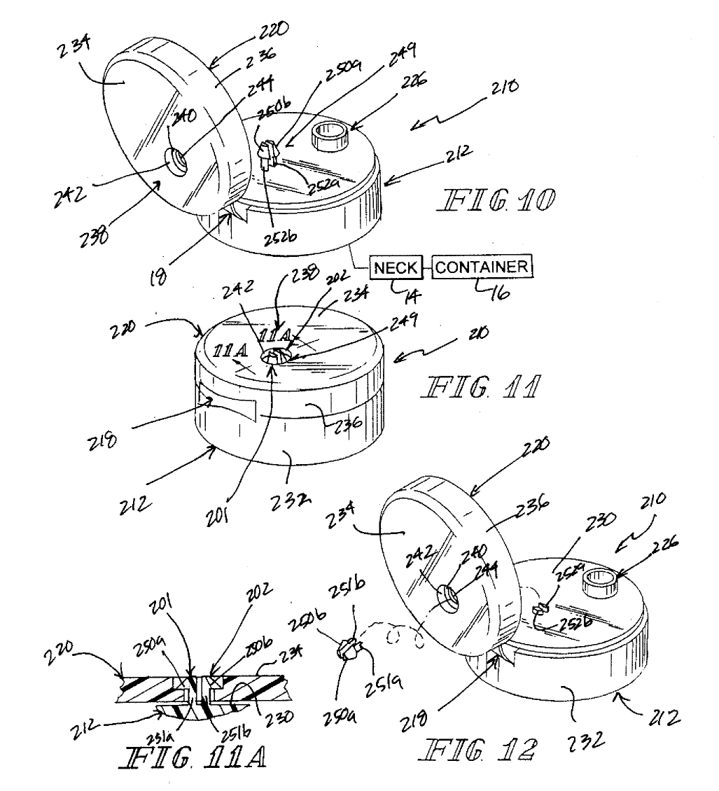

Flip-top cap 120 includes a top wall 134 and an annular side wall 136 depending from a peripheral portion of top wall 134 as suggested in FIGS. 5 and 6. Top wall 134 is formed to include an indicator-receiving aperture 138 as shown, for example, in FIGS. 5 and 8.

Hinge 118 is coupled to base 112 and to flip-top cap 120 to provide a “living” hinge as suggested in FIG. 5. Hinge 118 is flexible allowing tethered movement of flip-top cap 120 relative to base 112 after controlled breakage of tamper-evident indicator 122 (e.g., frangible tether strips 156) in a manner shown, for example, in FIG. 9.

Body 112 is formed to include a head-support pillar 152 rooted on top wall 130 of body 112 and formed to include a free end 154 as shown, for example, in FIG. 5. Head-support pillar 152 is arranged to lie in spaced-apart relation to product-dispensing spout 126 and between product-dispensing spout 126 and hinge 118 as suggested in FIG. 5.

Flip-top cap 120 also includes a breakaway head 150 and a frangible connector comprising, for example, several frangible tether strips 156 used to tether breakaway head 150 to top wall 134 of flip-top cap 120 to locate breakaway head 150 in indicator-receiving aperture 138 as suggested in FIGS. 5 and 6. Breakaway head 150 is formed to include a downwardly opening pillar receiver 153 sized to receive free end 154 of head-support pillar 152 therein as suggested in FIG. 8.

In an illustrative embodiment, each tether strip 156 has an outer end coupled to an interior edge 158 of flip-top cap 120 bordering indicator-receiving aperture 138 and an inner end coupled to a perimeter portion of breakaway head 150. In an illustrative embodiment, four tether strips 156 are provided and each pair of adjacent frangible tether strips 156 are separated by an included angle of about 90°. Tether strips 156 are somewhat stretchable to allow limited movement of breakaway head 150 from a raised position away from free end 154 of head-support pillar 152 suggested in FIG. 6 to a lowered position mating with free end 154 of head-support pillar 152 suggested in FIGS. 7 and 8.

Breakaway head 150, head-support pillar 152, and frangible tether strips 156 cooperate to define tamper-evident indicator 122 as suggested in FIGS. 7-9. During manufacture, flip-top cap 120 is moved from an opened position away from body 112 shown in FIG. 5 to a closed position mating with body 112 as shown in FIG. 6. At the same or a later time, a downward force 100 is applied to an exterior portion of breakaway head 150 to move breakaway head 150 in direction 101 from its raised position to its lowered position as suggested in FIGS. 7 and 8 to mate breakaway head 150 to head-support pillar 152 by causing free end 154 of head-support pillar 152 to extend upwardly into the downwardly opening pillar receiver 153 formed in breakaway head 150 as suggested in FIG. 8 and establish an interference fit between breakaway head 150 and head-support pillar 152. It is within the scope of this disclosure to establish a suitable friction or otherwise locking or ribbed fit between breakaway head 150 and free end 154 normally to retain breakaway head 150 in mating engagement with free end of head-support pillar 152 until flip-top cap 120 is later opened to break frangible tether straps 156.

When breakaway head 150 is moved in downward direction 101 by force 100 as suggested in FIGS. 7 and 8, frangible tether strips 156 are stretched and remained in a tensioned or stressed stretched condition until they are torn when flip-top cap 120 is opened. As suggested in FIGS. 7A and 8A, it is within the scope of this disclosure to rotate or twist breakaway head 150 using a torque 102 as it is pressed onto free end 154 of head-support pillar 152 using, for example, twisted ribs 155 to establish tamper-evident indicator 122′.

When flip-top cap 120 is opened for the first time after tamper-evident indicator 122 is established, each of frangible tether strips 156 will break as suggested in FIG. 9 separating breakaway head 150 from the rest of flip-top cap 120 and leaving breakaway head 150 in a mounted position on free end 154 of head-support pillar 152. This provides a visual indication that flip-top cap 120 has been opened for the first time. If breakaway head 150 is tethered to top wall 134 by frangible tether strips 156 then an observer can be confident that flip-top cap 120 has been unopened since filling of container 16.

A container closure 210 in accordance with another illustrative embodiment of the present disclosure includes a body 212 adapted to mount on a neck 14 of a container 16, a hinge 218, and a flip-top cap 220 as shown, for example, in FIG. 10. Body 212 and flip-top cap 220 cooperate to define a tamper-evident indicator 222 as suggested in FIG. 11. A first breakaway head 250a included in tamper-evident indicator 222 separates from a first head-support pillar 252a also included in indicator 222 as suggested in FIG. 12 when a user “opens” flip-top cap 220 for the first time. In an illustrative embodiment, a second breakaway head 250b included in tamper-evident indicator 222 separates from a second head-support pillar 252b as also suggested in FIG. 12 when a user opens flip-top cap 220 for the first time.

Closure 210 is monolithic and thus is formed as a single piece of plastics material, in three sections, to include body 212, hinge 218, and flip-top cap 220. Closure 210 is formed using any suitable injection-molding or compression-molding technique. It is within the scope of this disclosure to provide a container closure without a hinge.

Body 212 includes a top wall 230 formed to include a product-dispensing spout 226 and an annular side wall 232 depending from a perimeter portion of top wall 230 as suggested in FIG. 10. An interior surface of annular side wall 232 is threaded or configured in any suitable manner to mate with a companion finish on an exterior surface of container neck 14 to mount container closure 210 on container neck 14. It is within the scope of this disclosure to provide any suitable fluid seal on the underside of top wall 230 to establish a sealed connection between body 212 and container neck 14 when closure 210 is mounted on container neck 14.

Flip-top cap 220 includes a top wall 234 and an annular side wall 236 depending from a peripheral portion of top wall 234 as suggested in FIGS. 10 and 11. Top wall 234 is formed to include a flag receiver 238 as shown, for example, in FIG. 10. In an illustrative embodiment, flag receiver 238 includes a thin annular plate 240 coupled to a circular interior edge 242 formed in top wall 234 and annular plate 240 is formed to include an aperture 244. Annular plate 240 is arranged to lie in an opening defined by circular interior edge 242 as suggested in FIG. 10.

Hinge 218 is coupled to base 212 and to flip-top cap 220 to provide a “living” hinge as suggested in FIG. 10. Hinge 218 is flexible allowing tethered movement of flip-top cap 220 relative to base 212 after controlled breakage of tamper-evident indicator 222 in a manner shown, for example, in FIG. 12.

Body 212 is formed to include a frangible cap-opened signal flag 249 coupled to top wall 30 and arranged to lie in spaced-apart relation to product-dispensing spout 226 as shown, for example, in FIG. 10. In an illustrative embodiment, frangible cap-opened signal flag 249 includes a first frangible post 201 comprising first breakaway head 250a coupled to first head support pillar 252a and a second frangible post 202 comprising second breakaway head 150b coupled to second head-support pillar 252b as suggested, for example, in FIG. 10. Each of breakaway heads 250a and 250b includes an exterior partial frustoconical surface and an underlying and downwardly facing C-shaped surface located adjacent to the companion head-support pillar.

Tamper-evident indicator 222 is established by moving flip-top cap 220 from the opened position shown in FIG. 10 to the closed position shown in FIG. 11 to cause first and second breakaway heads 250a, 250b to be sheared off along frangible planes 251a, 251b as suggested in FIG. 12 to provide a visual indication that flip-top cap 220 has been opened. If breakaway heads 250a, 250b are present (e.g., visible) in flag receiver 238 as shown in FIG. 11, then observers can be confident that flip-top cap 220 has been unopened since filling of container 16.

1. A tamper-evident closure comprising
a body formed to include a frangible cap-opened signal flag and a product-dispensing spout and adapted to mount on a filler neck of a container and
a cap formed to include a flag-receiving aperture and configured to be moved from a closed position mounted on the body to cover the product-dispensing spout to an opened position separated from the body to uncover the product-dispensing spout, wherein the frangible cap-opened signal flag is arranged to extend through the flag-receiving aperture formed in the cap when the cap is mounted on the body to assume the closed position and wherein the frangible cap-opened signal flag and the cap cooperate to define tamper-evident indicator means for breaking the frangible cap-opened signal flag extending through the flag-receiving aperture formed in the cap the first time the cap is moved by a user relative to the body from the closed position to the opened position to provide a visual indication that the tamper-evident closure has been opened.

2. The tamper-evident closure of claim 1, wherein the cap includes a top wall arranged to overlie the product-dispensing spout when the cap is mounted on the body to assume the closed position, the top wall of the cap is formed to include the flag-receiving aperture, the frangible cap-opened signal flag includes a breakaway head located above an exterior portion of the top wall of the cap and a head-support pillar arranged to extend through the flag-receiving aperture and interconnect the breakaway head and the body, and the breakaway head is coupled to the head-support pillar by a frangible connection to remain in a visible position above the exterior portion of the top wall of the cap as long as the cap remains in the closed position on the body and to allow the breakaway head to be separated from the head-support pillar during first-time movement of the cap relative to the body from the closed position to the opened position.

3. The tamper-evident closure of claim 2, wherein the top wall includes an outer plate coupled to the annular side wall and formed to include an interior surface facing toward the product-dispensing spout included in the body when the cap lies in the closed position and an exterior surface facing away from the product-dispensing spout when the cap lies in the closed position and wherein the breakaway head includes a bottom wall coupled to the head-support pillar and arranged to lie in closely confronting relation to the exterior surface of the outer plate to engage the exterior surface of the outer plate during first-time movement of the cap relative to the body from the closed position to the opened position to apply an external force to the breakaway head to break the frangible cap-opened signal flag and cause the breakaway head to separate from the head-support pillar.

4. The tamper-evident closure of claim 3, wherein the cap further includes an annular side wall depending from a peripheral portion of the outer plate and mating with the body upon movement of the cap relative to the body to assume the closed position and wherein the annular side wall is arranged to surround the head-support pillar and the product-dispensing spout when the cap has been moved to assume the closed position.

5. The tamper-evident closure of claim 2, wherein the top wall includes an outer plate coupled to the annular side wall and a thin annular plate formed to include the flag-receiving aperture, the thin annular plate is coupled to an interior edge formed in the outer plate to cooperate with the interior edge to form an open recess containing the breakaway head prior to separation of the breakaway head form the head-support pillar during first-time movement of the cap relative to the body from the closed position to the opened position.

6. The tamper-evident closure of claim 5, wherein the breakaway head includes a bottom wall coupled to the head-support pillar and arranged to lie in the open recess in closely confronting relation to the thin annular plate to engage the thin annular plate during first-time movement of the cap relative to the body from the closed position to the opened position to apply an external force to the breakaway head to cause the breakaway head to separate from the head-support pillar.

7. The tamper-evident closure of claim 1, wherein the cap is a flip-top cap and further comprising a hinge coupled to the body and to the flip-top cap to support the flip-top cap for movement relative to the body from the closed position to the opened position to break the frangible cap-opened signal flag included in the body during first-time movement of the flip-top cap relative to the body from the closed position to the opened position.

8. The tamper-evident closure of claim 7, wherein the frangible cap-opened signal flag is positioned to lie in a space provided between the hinge and the product-dispensing spout when the flip-top cap is located in the closed position on the body.

9. The tamper-evident closure of claim 8, wherein the frangible cap-opened signal flag includes a breakaway head located above an exterior portion of the top wall of the flip-top cap and a head-support pillar arranged to extend through the flag-receiving aperture and interconnect the breakaway head and the body and wherein at least a portion of the head-support pillar lies in the space provided between the hinge and the product-dispensing spout before and after the breakaway head is separated from the head-support pillar during breakage of the frangible cap-opened signal flag caused by first-time movement of the flip-top cap from the closed position to the opened position.

10. The tamper-evident closure of claim 1, wherein the frangible cap-opened signal flag includes a first frangible pole coupled to the body and arranged to extend upwardly through the flag-receiving aperture formed in the cap and a second frangible post coupled to the body and arranged to lie in spaced-apart relation to the first frangible post and to extend upwardly through the flag-receiving aperture formed in the cap.

11. The tamper-evident closure of claim 10, wherein each of the first and second frangible posts includes a breakaway head located above an exterior portion of the top wall of the cap and a head-support pillar arranged to extend through the flag-receiving aperture and interconnect a companion breakaway head and the body and wherein each breakaway head is coupled to a companion head-support pillar by a frangible connection to remain in a visible position above the exterior portion of the top wall of the cap as long as the cap remains in the closed position on the body and to allow both of the breakaway heads to be separated from the companion head-support pillars during first-time movement of the cap relative to the body from the closed position to the opened position.

12. The tamper-evident closure of FIG. 11, wherein the top wall includes an outer plate coupled to the annular side wall and a thin annular plate formed to include the flag-receiving aperture, the thin annular plate is coupled to an interior edge formed in the outer plate to cooperate with the interior edge to form an open recess containing the breakaway head prior to separation of the breakaway head form the head-support pillar during first-time movement of the cap relative to the body from the closed position to the opened position.

13. The tamper-evident closure of FIG. 11, wherein the breakaway head includes a bottom wall coupled to the head-support pillar and arranged to lie in the open recess in closely confronting relation to the thin annular plate to engage the thin annular plate during first-time movement of the cap relative to the body from the closed position to the opened position to apply an external force to the breakaway head to cause the breakaway head to separate from the head-support pillar.

14. A tamper-evident closure comprising
a body formed to include a frangible cap-opened signal flag and a product-dispensing spout located in spaced-apart relation to the frangible cap-opened signal flag, the body being adapted to mount on a filler neck of a container,
a flip-top cap formed to include a flag-receiving aperture, and
a hinge coupled to the body and to the flip-top cap to support the flip-top cap for movement from a closed position on the body locating the frangible cap-opened signal flag in the flag-receiving opening and covering the product-dispensing spout to an opened position away from the body uncovering the product-dispensing spout, and breaking the frangible cap-opened signal flag to provide a visual indication that the tamper-evident closure has been opened.

15. The tamper-evident closure of claim 14, wherein the flip-top cap includes a top wall arranged to overlie the product-dispensing spout when the flip-top cap is mounted on the body to assume the closed position, the top wall of the flip-top cap is formed to include the flag-receiving aperture, the frangible cap-opened signal flag includes a breakaway head located above an exterior portion of the top wall of the flip-top cap and a head-support pillar arranged to extend through the flag-receiving aperture and interconnect the breakaway head and the body, and the breakaway head is coupled to the head-support pillar by a frangible connection to remain in a visible position above the exterior portion of the top wall of the flip-top cap as long as the flip-top cap remains in the closed position on the body and to allow the breakaway head to be separated from the head-support pillar during first-time movement of the flip-top cap relative to the body from the closed position to the opened position.

16. The tamper-evident closure of claim 15, wherein the top wall includes an outer plate coupled to the annular side wall and formed to include an interior surface facing toward the product-dispensing spout included in the body when the flip-top cap lies in the closed position and an exterior surface facing away from the product-dispensing spout when the flip-top cap lies in the closed position and wherein the breakaway head includes a bottom wall coupled to the head-support pillar and arranged to lie in closely confronting relation to the exterior surface of the outer plate to engage the exterior surface of the outer plate during first-time movement of the flip-top cap relative to the body from the closed position to the opened position to apply an external force to the breakaway head to break the frangible cap-opened signal flag and cause the breakaway head to separate from the head-support pillar.

17. The tamper-evident closure of claim 15, wherein the top wall includes an outer plate coupled to the annular side wall and a thin annular plate formed to include the flag-receiving aperture, the thin annular plate is coupled to an interior edge formed in the outer plate to cooperate with the interior edge to form an open recess containing the breakaway head prior to separation of the breakaway head form the head-support pillar during first-time movement of the flip-top cap relative to the body from the closed position to the opened position.

18. A tamper-evident closure comprises
a body formed to include a product-dispensing spout and adapted to mount on a filler neck of a container,
a flip-top cap including a top wall formed to include an indicator-receiving aperture, and
a hinge coupled to the body and to the flip-top cap to support the flip-top cap for movement from a closed position on the body covering the product-dispensing spout to an opened position away from the body uncovering the product-dispensing spout, wherein the body and the flip-top cap cooperate to define a tamper-evident indicator extending into the indicator-receiving aperture and including a head-support pillar included in the body and formed to have a free end, a breakaway head coupled to the free end of the head-support pillar, and a frangible connector interconnecting the top wall to the breakaway head to support the breakaway head in a visible position in the indicator-receiving aperture when the flip-top cap has been moved to assume the closed position and breaking to separate the top wall from the breakaway head in response to first-time movement of the flip-top cap from the closed position to the opened position to provide a visual indication that the tamper-evident closure has been opened.

19. The tamper-evident closure of claim 18, wherein the breakaway head is formed to include a downwardly opening pillar receiver receiving the free end of the head-support pillar therein.

20. The tamper-evident closure of claim 18, wherein the frangible connector includes several frangible tether strips and each tether strip has an outer end coupled to an interior edge of the top wall bordering the indicator-receiving aperture and an inner end coupled to a perimeter portion of the breakaway head.
